(19) United States
(12) Patent Application Publication
(10) Pub. No.: US 2009/0041014 A1
(43) Pub. Date: Feb. 12, 2009

(54) Obtaining Information From Tunnel Layers Of A Packet At A Midpoint

(76) Inventors: Walter G. Dixon, Fuquay Varina, NC (US); Robert A. Mackie, Cary, NC (US); Richard L. Gray, Cary, NC (US)

Correspondence Address: BAKER BOTTS L.L.P., 2001 ROSS AVENUE, SUITE 600, DALLAS, TX, 75201-2980, US

(21) Appl. No.: 11/835,556

(22) Filed: Aug. 8, 2007

(51) Int. Cl. H04L 12/56

(52) U.S. Cl. 370/392

(57) ABSTRACT

In one embodiment, a midpoint obtains information from packets by monitoring a communication session between a subscriber side endpoint and a network side provider. The communication session involves a packet flow comprising one or more packets, where a packet comprises tunnel layers. The midpoint establishes one or more target layers of the tunnel layers and performs the following for each tunnel layer at least until a last target layer is reached: identifies a protocol associated with a tunnel layer, parses the packet according to the identified protocol, and extracts target information from the tunnel layer if the tunnel layer is a target layer.

### TECHNICAL FIELD

This invention relates generally to the field of telecommunications.

### BACKGROUND

In certain communication networks, a content provider may provide content to an endpoint and may charge the endpoint for the service. A billing system may determine how much the endpoint is to be charged for the service. Known billing systems, however, may not be able to effectively obtain information to determine how much the endpoint should be charged. In certain situations, it may be desirable to effectively obtain this information.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system that provides services to an endpoint;

FIG. 2 illustrates examples of packets; and

FIG. 3 illustrates one embodiment of a method for determining a policy for a packet flow that may be used by the system of FIG. 1.

### DETAILED DESCRIPTION OF THE DRAWINGS OVERVIEW

According to one embodiment, a midpoint obtains information from packets by monitoring a communication session between a subscriber side endpoint and a network side provider. The communication session involves a packet flow comprising one or more packets, where a packet comprises tunnel layers. The midpoint establishes one or more target layers of the tunnel layers and performs the following for each tunnel layer at least until a last target layer is reached: identifies a protocol associated with a tunnel layer, parses the packet according to the identified protocol, and extracts target information from the tunnel layer if the tunnel layer is a target layer.

Description

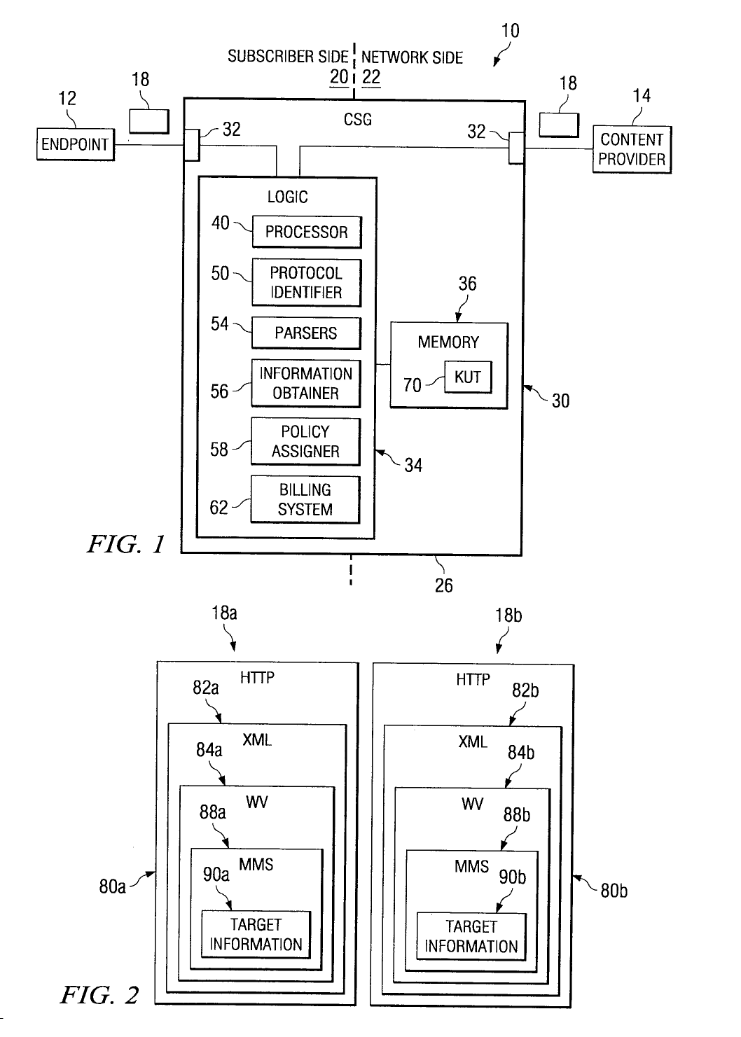

FIG. 1 illustrates one embodiment of a system 10 that provides services, for example, content services, to an endpoint 12. In the embodiment, a midpoint 26 may determine a billing policy for endpoint 12 in accordance with target information obtained from intercepted packets. Midpoint 26 may parse an intercepted packet until a tunnel layer that includes the target information is reached. Midpoint 26 may then establish the policy from the target information.

According to the illustrated embodiment, system 10 provides services such as communication sessions to endpoints 12. A communication session may refer to an active communication of packets 18. Information may be communicated during a communication session. Information may refer to voice, data, text, audio, video, multimedia, control, signaling, other information, or any combination of any of the preceding.

System 10 may utilize communication protocols and technologies to provide the communication sessions. Examples of communication protocols and technologies include those set by the Institute of Electrical and Electronics Engineers, Inc. (IEEE) 802.xx standards, the International Telecommunications Union (ITU-T) standards, the European Telecommunications Standards Institute (ETSI) standards, the Internet Engineering Task Force (IETF) standards, the Third Generation Partnership Project (3GPP) standards (including 3GPP, 3GPP2, and other 3GPP standards), or other standards.

A packet 18 comprises a bundle of data organized in a specific way for transmission. According to one embodiment, packet 18 may be tunneled. Tunneling may refer to the process of encapsulating one packet into another packet, for example, encapsulating a data packet in an Internet Protocol (IP) packet for transmission across an IP network. Examples of tunneling protocols include the hypertext transfer protocol (HTTP) tunneling protocol.

As a packet is encapsulated in another packet, a new tunnel layer is formed. Thus, the resulting packet 18 may have multiple tunnel layers. Moreover, each tunnel layer may be encapsulated according to a different protocol. Examples of protocols include 3GPP protocols such as the Multimedia Messaging Service (MMS) protocol. Other examples include the Wireless Access Protocol (WAP), Wireless Village (WV) protocol, hypertext transfer protocol (HTTP), extensible markup language (XML), or other protocol. Packets 18 may be tunneled using any suitable protocols in any suitable order, for example, MMS over WAP, MMS over HTTP, MMS over WAP2 over HTTP, or MMS over wireless village over XML over HTTP. The protocols may be in any suitable order, such as in the reverse order of the previous examples, for example, WAP over MMS. Examples of packets 18 are described in more detail with reference to FIG. 2.

FIG. 2 illustrates examples of packets 18. In the illustrated embodiment, packets 18 include tunnel layers 80, 82, 84, 88. Packet 18a includes tunnel layers 80a, 82a, 84a, 88a, and packet 18b includes tunnel layers 80b, 82b, 84b, 88b. A tunnel layer may be encapsulated using any suitable protocol. In the illustrated embodiment, tunnel layers 80a-b use HTTP, tunnel layers 82a-b use XML, tunnel layers 84a-b use WV, and tunnel layers 88a-b use MMS.

In some packets 18, a tunnel layer 82 may be associated with more than one protocol, that is, have an implicit tunnel layer 92. Tunnel layer 82 may indicate the change from one protocol to another protocol.

One or more tunnel layers may be target layers that include target information. Target information may refer to information that may be used to perform particular communication operations such accounting operations, data mining operations, content filtering operations, and/or other suitable operation. In one embodiment, target information may be used to select a billing policy to apply to a packet flow in order to charge endpoint 12 for the packet flow. For example, the target information may include an endpoint identifier, a user identifier, a billing code, and/or other suitable information. In the illustrated embodiment, target information 90a-b is located at tunnel layer 88a-b.

Target information may be obtained from one or more packets 18. In one embodiment, target information from packets 18a-b may be needed to determine a billing policy. Packets 18a-b may be received from the same sender (either endpoint 12 or content provider 14), where one is received before the other. Alternatively, packet 18a may be received from one sender, and packet 18b may be received from another sender. For example, packet 18a may be a request, and packet 18b may be a response to the request.

Modifications, additions, or omissions may be made to packets 18 without departing from the scope of the invention. The packets 18 may include more, fewer, or other layers. Additionally, the layers may be arranged in any suitable order.

Referring back to FIG. 1, communication system 10 includes a subscriber side 20 and a network side 22. Subscriber side 20 may refer to the side of communication system 10 at which endpoint 12 of the subscriber is located. Network side 22 may refer to the side of communication system 10 at which content provider 14 is located.

Endpoint 12 represents any suitable component operable to communicate with a communication system. Examples of endpoint 12 include a telephone, a personal digital assistant, a computer, a mobile handset, or any other device operable to communicate with system 10.

A midpoint 26 may refer to a node that is located between subscriber side 20 and network side 22. According to one embodiment, a midpoint 26 may be located at an access network that provides endpoint 12 with access to a backbone network.

In one embodiment, a midpoint 26 may represent a content services gateway (CSG) 30. CSG 30 monitors information within a packet flow to provide communication operations such as access control operations and/or accounting operations. In one embodiment, CSG 30 may obtain target information from tunnel layers of a packet 18 and determine a policy (such as a billing policy) in accordance with the target information. CSG 30 may obtain the information without terminating a message from one side and generating a new one for the other side. That is, CSG need not operate as a transparent proxy.

In one embodiment, CSG 30 may process packets 18 that have multiple tunnel layers. For example, at each tunnel layer, CSG 30 may identify a protocol associated with the tunnel layer and parse the packet according to the identified protocol. CSG 30 may process the tunnel layers until a target layer that includes the target information is reached. When the target layer is reached, CSG 30 may extract the target information from the target layer.

CSG 30 may include any suitable elements for obtaining target information and/or determining a policy. In the illustrated embodiment, CSG 30 includes an interface 32, logic 34, and a memory 36. Logic 34 may include a processor 40 and application such as a protocol identifier 50, parsers 54, an information obtainer 56, a policy assigner 58, and a billing system 62. Memory 36 may include a known user table (KUT) 70.

In one embodiment, interface 32 receives input, sends output, processes the input and/or output, performs other suitable operation, or performs a combination of any of the preceding. An interface may comprise hardware and/or software. In the illustrated embodiment, input and output comprises packets 18.

Logic 34 performs the operations of CSG 30, for example, logic may execute instructions to generate output from input. Logic 34 may include hardware, software, other logic, or a combination of any of the preceding.

Processor 40 manages the operation of CSG 30, and may perform the operations of CSG 30 by executing applications. Examples of processor 10 may include one or more computers, one or more microprocessors, one or more applications, other logic, or a combination of any of the preceding.

Protocol identifier 50 identifies the protocols associated with the tunnel layers of packet 18. Protocol identifier 50 may identify a protocol in any suitable manner. According to one embodiment, a communications standard may designate that particular tunnel layers are associated with particular protocols. For example, an outer tunnel layer uses protocol X, a next tunnel layer uses protocol Y, and so on. Protocol identifier 50 may use the communications standard to identify the protocol.

According to another embodiment, the protocol may be identified by techniques other than a standard. In one example, a previous tunnel layer may indicate the protocol of a next tunnel layer. For example, the previous tunnel layer may indicate the next tunnel layer uses protocol Z. Protocol identifier 50 may use this information to identify the protocol. In another example, a first portion of a tunnel layer may indicate the protocol of a second portion of the tunnel layer. For example, the first portion may indicate the second portion uses protocol Z. Protocol identifier 50 may use this information to identify the protocol. In yet another example, features of a tunnel layer may be indicative of protocol Z. Protocol identifier 50 may use these features to identify the protocol.

Parsers 50 parse packet 18 according to the protocol of the tunnel layer in order to reach the next tunnel layer. Parsers 54 may include parsers for specific protocols.

Information obtainer 56 obtains target information from a target layer. Information obtainer 56 may identify the target layer in any suitable manner. According to one embodiment, information obtainer 56 may be programmed to obtain target information from a tunnel layer associated with a specific protocol. For example, information obtainer may be programmed to obtain information from an MMS tunnel layer. If protocol identifier 50 identifies the protocol of a tunnel layer as MMS, information obtainer 56 may obtain the information from that tunnel layer.

Information obtainer 56 may store target information from one or more packets 18 at KUT 70. In one embodiment, target information from multiple packets 18 may be needed, for example, to determine a policy. In this embodiment, information obtainer 56 may store the target information as it is obtained from each packet 18 such that the target information from the packets 18 may be readily retrieved.

Policy assigner 58 determines a policy for a packet flow. Policy assigner 58 may determine one or more policies according to target information obtained from one or more tunnel layers. As a first example, a policy may be determined using target information obtained from a single tunnel layer. As a second example, a policy may be determined using target information obtained from multiple tunnel layers. As a third example, a separate policy may be determined using target information for each tunnel layer of multiple tunnel layers. In this example, a packet flow may be charged according to different policies for the content at different tunnel layers.

In one embodiment, policy assigner 58 may determine a billing policy for a packet flow, and may notify billing system 62 of the policy. Billing system 62 charges endpoint 12 according to the policy provided by policy assigner 58.

Billing system 62 may take into account any suitable parameter for charging endpoint 12. Billing parameters may describe how endpoint 12 accesses system 10, for example, the geographic position of endpoint 12 or the nodes used by endpoint 12 to access system 10. Billing parameters may describe fee structures such as pricing per download, pricing per byte, or pricing for a selected time interval. Billing parameters describe how content was accessed, such as the URL used to access content, the nature and/or size of content, the time when the content is accessed, and the protocol used to access the content.

Memory 36 stores information. Memory 36 may comprise computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), other computer-readable medium, or a combination of any of the preceding.

Memory 36 stores known user table (KUT) 70. KUT 70 stores information about communication sessions that system 10 is monitoring. The information may be indexed according to the endpoints 12 involved in the communication sessions. For example, KUT 70 may include identifiers of endpoints 12 (such as IP addresses of endpoints 12), and may associate information related to an endpoint 12 with the identifier of the endpoint 12.

According to one embodiment, KUT 70 stores target information obtained from packets 18. In certain examples, the target information from only one packet 18 may be stored. In other examples, the target information from multiple packets 18 may be stored. In one embodiment, KUT 70 may also store policy information about a policy determined according to the target information.

Content provider 14 represents an entity that provides content to subscribers such as endpoint 12. Content provider 14 may include a server that may be accessed by endpoint 12 to provide the content.

System 10 may include one or more networks that allow the components of system to communicate. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

Modifications, additions, or omissions may be made to system 10 without departing from the scope of the invention. The components of system 10 may be integrated or separated. Moreover, the operations of system 10 may be performed by more, fewer, or other components. For example, the operations of protocol identifier 50 and parsers 54 may be performed by one component, or the operations of billing system 62 may be performed by more than one component. Additionally, operations of system 10 may be performed using any suitable logic. As used in this document, “each” refers to each member of a set or each member of a subset of a set.

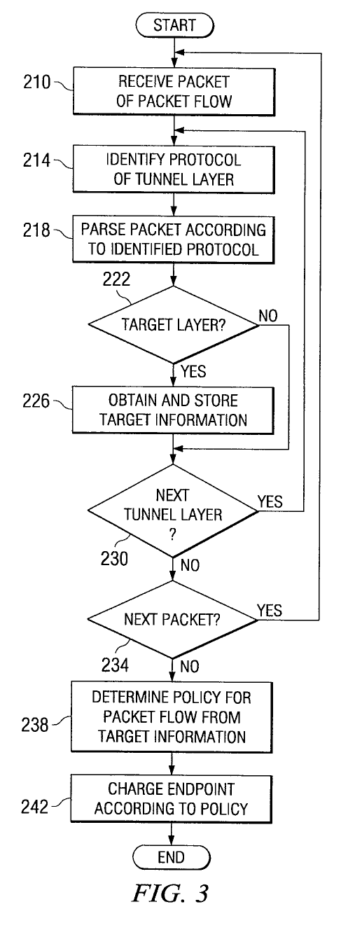

FIG. 3 illustrates one embodiment of a method for determining a policy for a packet flow that may be used by system 10 of FIG. 1. The method starts at step 210, where CSG 30 receives packet 18. Packet 18 may be received from endpoint 12 or from content provider 14. Protocol identifier 50 of CSG 30 identifies the protocol of a tunnel layer of packet 18 at step 214. When packet 18 is first received, the protocol of the outer tunnel layer is typically identified. A parser 54 parses packet 18 according to the identified protocol at step 218.

The tunnel layer may be a target layer of one or more target layers that include target information at step 222. If the tunnel layer is a target layer at step 222, the method proceeds to step 226, where information obtainer 56 obtains and stores the target information. The target information may be stored at KUT 70. The method then proceeds to step 230. If the tunnel layer is not a target layer at step 222, the method proceeds directly to step 230.

The packet may have a next tunnel layer (which may or may not be a target layer) at step 230. If the packet has a next tunnel layer the method returns to step 214, where protocol identifier 50 identifies the protocol of the next tunnel layer. If there is no next tunnel layer at step 230, the method proceeds to step 234.

A next packet 18 may be needed to obtain more target information at step 234. The next packet 18 may be received from the sender or the receiver of the preceding packet 18. If there is a next packet 18 at step 234, the method returns to step 210, where the next packet 18 is received. If there is no next packet at step 234, the method proceeds to step 238.

Policy assigner 58 determines the policy of the packet flow from the target information at step 238. The policy may refer to, for example, a billing policy. In one embodiment, different policies may be determined for different tunnel layers of the packet flow. Policy assigner 58 may notify billing system 62 of the policy. Billing system 62 charges the data flow based on the policy at step 242. After charging the endpoint 12, the method ends.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that a midpoint may determine a billing policy for an endpoint receiving content from a content provider. The billing policy may be determined in accordance with target information obtained from one or more tunnel layers of a packet. For example, the midpoint may parse the packet until a tunnel layer that includes the target information is reached. The midpoint may then establish the policy from the target information.

Another technical advantage of one embodiment may be that the midpoint may obtain the target information from multiple packets to establish the policy. For example, the midpoint may obtain some target information from a request message and other target information from a response message.

Another technical advantage of one embodiment may be that the midpoint may obtain the target information from intercepted packets. Accordingly, the midpoint is not required to operate as an endpoint, and may obtain the information without disrupting the flow of packets.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising:
monitoring, by a midpoint, a communication session between a subscriber side endpoint and a network side provider, the communication session involving a packet flow comprising one or more packets, a packet comprising a plurality of tunnel layers; and
performing the following at the midpoint for each packet of the one or more packets:
establishing one or more target layers of the plurality of tunnel layers of the each packet; and
performing the following for each tunnel layer at least until a last target layer of the one or more target layers is reached:
identifying a protocol associated with the each tunnel layer;
parsing the packet according to the identified protocol; and
extracting target information from the each tunnel layer if the each tunnel layer is a target layer.

2. The method of claim 1, further comprising:
determining one or more policies for the packet flow in accordance with the target information from the one or more target layers.

3. The method of claim 1, further comprising:
determining one or more policies for the packet flow in accordance with the target information, the one or more policies comprising at least one of:
a billing policy;
a data mining policy; and
a content filtering policy.

4. The method of claim 1, the one or more packets comprising:
a request message; and
a response message responding to the request message.

5. The method of claim 1, the one or more packets comprising:
a first packet received from a sender comprising the endpoint or the provider; and
a second packet received from the sender.

6. The method of claim 1, identifying the protocol associated with the each tunnel layer further comprising:
identifying the protocol according to a protocol standard.

7. The method of claim 1, identifying the protocol associated with the each tunnel layer further comprising:
identifying the protocol from a previous tunnel layer.

8. The method of claim 1, identifying the protocol associated with the each tunnel layer further comprising:
detecting an implicit tunnel layer of the each tunnel layer; and
identifying the protocol associated with the implicit tunnel layer using the each tunnel layer.

9. An apparatus, comprising:
a memory operable to store information about a communication session between a subscriber side endpoint and a network side provider, the communication session involving a packet flow comprising one or more packets, a packet comprising a plurality of tunnel layers; and
one or more processors operable to:
perform the following for each packet of the one or more packets:
establish one or more target layers of the plurality of tunnel layers of the each packet; and
perform the following for each tunnel layer at least until a last target layer of the one or more target layers is reached:
identify a protocol associated with the each tunnel layer;
parse the packet according to the identified protocol; and
extract target information from the each tunnel layer if the each tunnel layer is a target layer.

10. The apparatus of claim 9, the one or more processors further operable to:
determine one or more policies for the packet flow in accordance with the target information from the one or more target layers.

11. The apparatus of claim 9, the one or more processors further operable to:
determine one or more policies for the packet flow in accordance with the target information, the one or more policies comprising at least one of:
a billing policy;
a data mining policy; and
a content filtering policy.

12. The apparatus of claim 9, the one or more packets comprising:
a request message; and
a response message responding to the request message.

13. The apparatus of claim 9, the one or more packets comprising:
a first packet received from a sender comprising the endpoint or the provider; and
a second packet received from the sender.

14. The apparatus of claim 9, the one or more processors further operable to identify the protocol associated with the each tunnel layer by:
identifying the protocol according to a protocol standard.

15. The apparatus of claim 9, the one or more processors further operable to identify the protocol associated with the each tunnel layer by:
identifying the protocol from a previous tunnel layer.

16. The apparatus of claim 9, the one or more processors further operable to identify the protocol associated with the each tunnel layer by:
detecting an implicit tunnel layer of the each tunnel layer; and
identifying the protocol associated with the implicit tunnel layer using the each tunnel layer.

17. A system, comprising:
means for monitoring, by a midpoint, a communication session between a subscriber side endpoint and a network side provider, the communication session involving a packet flow comprising one or more packets, a packet comprising a plurality of tunnel layers; and
means for performing the following at the midpoint for each packet of the one or more packets:
establishing one or more target layers of the plurality of tunnel layers of the each packet; and
performing the following for each tunnel layer at least until a last target layer of the one or more target layers is reached:
identifying a protocol associated with the each tunnel layer;
parsing the packet according to the identified protocol; and
extracting target information from the each tunnel layer if the each tunnel layer is a target layer.
